(19) United States
(12) Patent Application Publication
(10) Pub. No.: US 2012/0260113 A1
(43) Pub. Date: Oct. 11, 2012

(54) Changing Device Behavior Based on External Information

(75) Inventors: Zhexuan Song, Sunnyvale, CA (US); Alvaro A. Cárdenas Mora, Sunnyvale, CA (US); Ryusuke Masuoka, San Jose, CA (US)

(73) Assignee: FUJITSU LIMITED, Kanagawa (JP)

(21) Appl. No.: 13/082,951

(22) Filed: Apr. 8, 2011

(51) Int. Cl. G06F 1/32; G06F 15/177

(52) U.S. Cl. 713/320; 709/221

(57) ABSTRACT

A first electronic device comprises an information-filtering module configured to identify one or more second electronic devices that supply one or more types of information needed by the first electronic device; an information-gathering module coupled to the information-filtering module configured to collect information from the second electronic devices; and an operation module coupled to the information-gathering module configured to adjust operational behavior of the first electronic device based on the collected information.

### TECHNICAL FIELD

This disclosure generally relates to devices that are capable of adjusting their operational behaviors based on external information.

### BACKGROUND

Many types of electronic devices are network capable and may be connected to a computer or communication network. Connecting multiple devices to a network provides several benefits. For example, the devices may report their status to a central point so that a user may easily determine the current operational conditions of these devices. The user may also control and manage the devices remotely.

### BRIEF DESCRIPTION OF THE DRAWINGS

FIG. 1 illustrates an example system that includes a number of information providers and information consumers connected to a network.

FIGS. 2A-2C illustrate three examples of an information consumer.

FIG. 3 illustrates an example application of the system illustrated in FIG. 1.

FIG. 4 illustrates an example method for an information consumer to subscribe to information from specific information providers.

FIG. 5 illustrates an example method for an information consumer to adjust its operational behavior based on the external information received from information providers.

FIG. 6 illustrates an example network environment.

FIG. 7 illustrates an example computer system.

### DESCRIPTION OF EXAMPLE EMBODIMENTS

Many types of electronic devices are network capable and may be connected to a network. Often, individual devices may communicate and exchange information with each other over the network. At the same time, more and more sensors of various types (e.g., motion, temperature, or lighting) are deployed in various environments (e.g., homes, offices, or shops). These sensors may be incorporated in or connected to specific electronic devices, and collect various types of information (e.g., environmental information) that may be used by the associated electronic devices.

For example, a lighting system deployed in an office may incorporate or connect to a motion sensor. The motion sensor may detect the movements in the office and report the information to a controller of the lighting system. When no movement is detected by the motion sensor for a period of time (e.g., 5 minutes), the controller may cause the lights in the office to be turned off in order to save energy. As another example, an air condition system installed in a home may incorporate a temperature sensor. The temperature sensor may detect the temperature in the home and report the information to a controller of the air condition system. When the temperature in the home is above a threshold (e.g., a preset degree), the controller may cause the air condition to be turned on to cool the home down. Conversely, when the temperature in the home is below a threshold, the controller may cause the air condition to be shut down.

Currently, although there may be multiple sensors or multiple types of sensors deployed in an environment (e.g., a house, a building, or a room), the individual sensors are often connected to and used by specific electronic devices only. For example, a motion sensor may be connected to and used by a lighting system, while a temperature sensor may be connected to and used by an air condition system. In a sense, each sensor is bound to and used by an associated device. The motion sensor is not used by the air condition system, and the temperature sensor is not used by the lighting system. As a result, the devices in an environment do not fully utilize all the information that may be available to them (e.g., information collected by the different types of sensors).

In particular embodiments, an electronic device may be connected to a network that includes other electronic devices. The device may receive information from some or all of the other devices over the network. This information may be referred to as “external” information with respect to the device as the information originates from other sources than the device itself. In particular embodiments, the device may adjust its operational behavior based on the external information it has received.

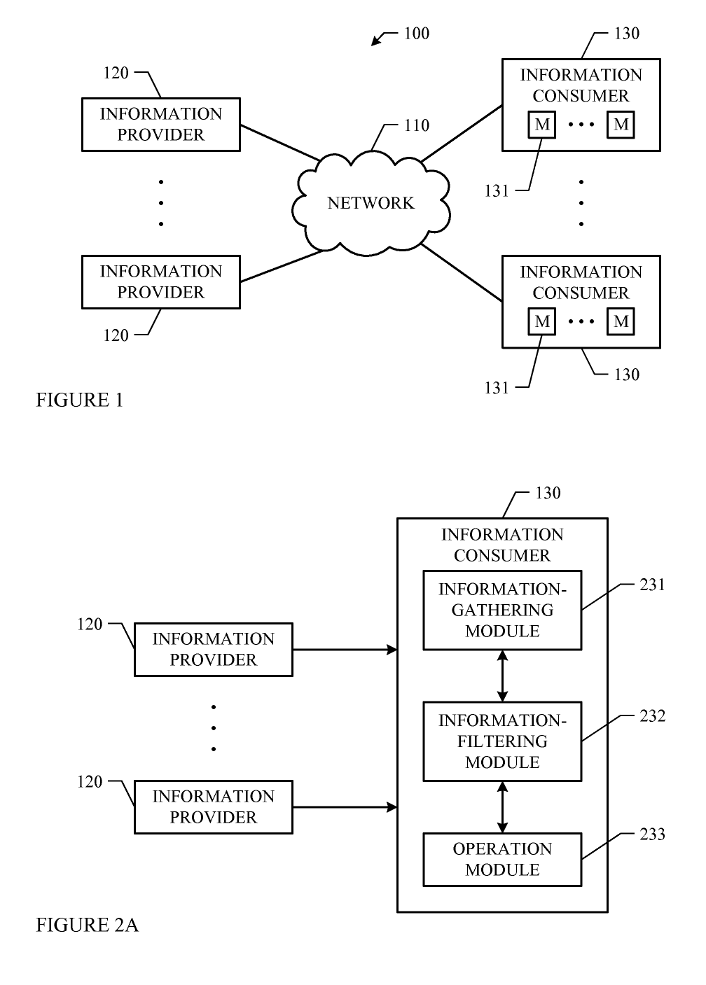

FIG. 1 illustrates an example system 100 that includes a number of information providers 120 and information consumers 130 connected to a network 110. In particular embodiments, network 110 may be any type of network (e.g., computer or communication network), such as, for example and without limitation, home are network (HAN), neighborhood area network (NAN), or local are network (LAN). The connections may be wire line or wireless connections. In particular embodiments, each information provider 120 and information consumer 130 may be an electronic device capable of connecting to network 110 and communicating with other devices over network 110. For example, information providers 120 and information consumers 130 may exchange information with each other over network 110. Information providers 120 and information consumers 130 may communicate with each other using any suitable network or communication protocol (e.g., UPnP (Universal Plug and Play), ZigBee, or 6LoWPAN (IPv6 over Low power Wireless Personal Area Networks)).

Note that there may be any number of various types of information providers 120 and information consumers 130 connected to network 110. An information consumer 130 may choose to receive external information from any one of information providers 120 connected to network 110. Thus, an information provider 120 is not bound to any one specific information consumer 130 but may supply information to all information consumers 130 that choose to subscribe to its information.

In particular embodiments, an information provider 120 may refer to a device that is capable of providing some type of information to one or more other devices, while an information consumer 130 may refer to a device that receives some type of information from one or more other devices. A device may be either an information provider 120 or an information consumer 130 or both. For example, a sensor may be an information provider 120 as it provides some type of sensor information (e.g., motion, temperature, or lighting) to other devices. A home appliance (e.g., a refrigerator or a television) may be an information consumer 130 as it receives some type of information from other devices (e.g., sensor information from sensors). A computing device may be both an information provider 120 and an information consumer 130 as it may receive information (e.g., sensor information) from other devices and provide information (e.g., its own status or information it has obtained) to other devices.

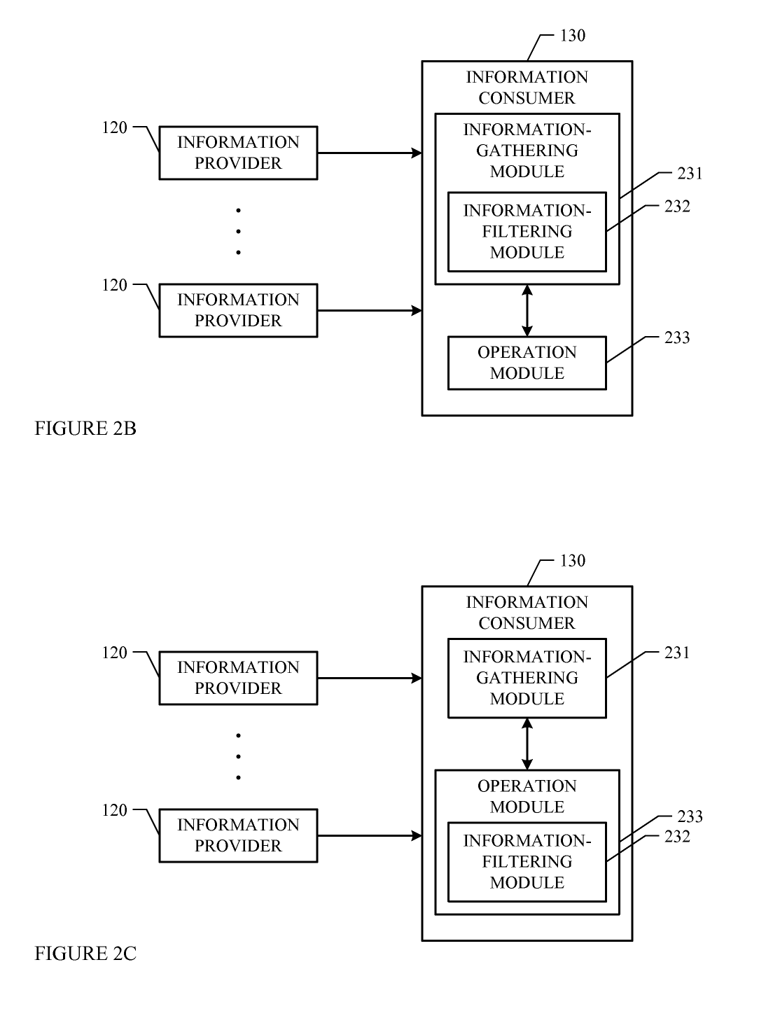

In particular embodiments, an information consumer 130 (e.g., an electronic device) may include any number of hardware or software modules 131. FIGS. 2A-2C illustrate three examples of a device that is an information consumer 130. In particular embodiments, information consumer 130 may include an information-gathering module 231, an information-filtering module 232, and an operation module 233. Each module 231, 232, 233 may be implemented as computer hardware or software or a combination thereof. Information-gathering module 231 may subscribe and collect external information from information providers 120. Information-filtering module 232 may filter the external information received from information providers 120 and select specific information that is useful to information consumer 130 itself. Operation module 233 may implement various device operations of information consumer 130 and adjust the operational behavior of information consumer 130 based on the external information received from information providers 120.

There may be different implementations of information-gathering module 231, information-filtering module 232, and operation module 233. For example, in FIG. 2A, the information-gathering module 231, information-filtering module 232, and operation module 233 are implemented as three independent modules coupled to each other. In FIG. 2B, information-filtering module 232 is a part of information-gathering module 231, while operation module 233 is a separate module coupled to information-gathering module 231. In FIG. 2C, information-filtering module 232 is a part of operation module 233, while information-gathering module 231 is a separate module coupled to operation module 233.

The different implementations may affect how and when the external information is filtered. Not all information available to a device over a network may be useful to or needed by the device. For example, system 100 illustrated in FIG. 1 may include a motion sensor and a temperature sensor as information providers 120 and a television as an information consumer 130. The television may receive motion information from the motion sensor and temperature information from the temperature sensor over network 110. However, the temperature information may not be useful to the television. Thus, in particular embodiments, an information consumer 130 may filter the available external information and only collect the specific information that is useful to or needed by it.

In the example implementation of information consumer 130 illustrated in FIG. 2A, information-gathering module 231 may collect all available external information over a network and pass the collected information to information-filtering module 232. Information-filtering module 232 may filter the collected external information and select specific information that is useful to information consumer 130. Information-filtering module 232 may then pass the filtered useful external information to operation module 233.

Alternatively, in the example implementation of information consumer 130 illustrated in FIG. 2B, information-filtering module 232 may determine once which specific information providers 120 supply information that is useful to or needed by information consumer 130. Information-gathering module 231 may only subscribe to and collect the useful external information from these specific information providers 120. In this case, all of the collected information is passed to operation module 233 as it is information useful to or needed by information consumer 130.

Alternatively, in the example implementation of information consumer 130 illustrated in FIG. 2C, information-gathering module 231 may collect all available external information over a network and pass the collected information to operation module 233. Information-filtering module 232 may identify which external information is useful and which is not. Operation module 233 may only process the useful information and ignore the rest.

In particular embodiments, each electronic device who is an information consumer 130 may adjust its operational behavior based on the external information it has received from one or more other information providers 120. What types of information a device may use and how a device may adjust its operational behavior based on the various types of external information is device specific. That is, different devices or different types of devices may need different types of information and may adjust their operational behaviors based on different configurations, settings, or rules. In particular embodiments, each device may have a default configuration (e.g., specified by the device manufacturer) that specifies what specific types of information the device needs and should collect, and how the device should adjust its operational behavior based on these specific types of information. Sometimes, a device may also provide a user interface that enables a device user to customize the device's configuration. For example, a lighting controller may have a default setting that specifies that if there is no movement detected by a motion sensor in a room for 5 minutes, the controller should turn off the lights in the room. However, a user may customize the setting to specify that if there is no movement detected by the motion sensor in the room for 3 minutes, the controller should turn off the lights in the room.

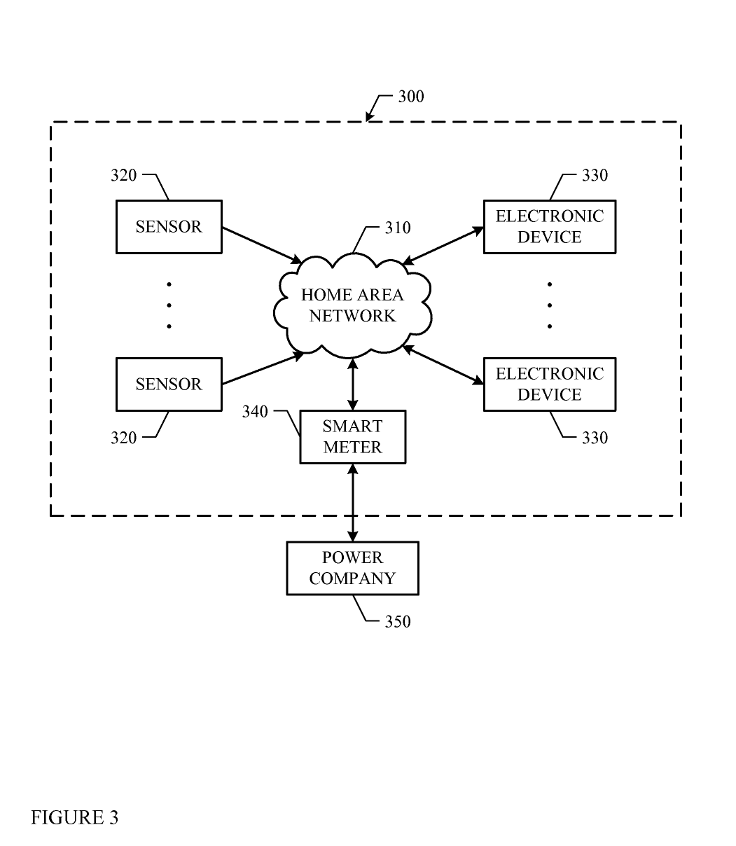

System 100 illustrated in FIG. 1 have many practical applications. One example application may be to save energy consumption in an environment (e.g., a home or an office building). FIG. 3 illustrates an example application of system 100. In this example, an environment 300 (e.g., a home) may have a home area network (HAN) 310 connecting a number of sensors 320, a number of electronic devices 330 (e.g., computers, printers, projectors, televisions, or home appliances), and a smart meter 340. Sensors 320 may function as information providers to supply various types of sensor information. Electronic devices 330 and smart meter 340 may function as both information providers and information consumers. For example, a device 330 may receive information from sensors 320 and other devices 330 as well as supply information (e.g., its current operational status or power consumption level) to other devices 330 and smart meter 340. In particular embodiments, smart meter 340 may function as a gateway to the world outside of environment 300 (e.g., the home), sending information about environment 300 to the outside world and relaying information received from the outside world to devices 330 over HAN 310. For example, smart meter 340 may be connected to a power company 350 supplying power to environment 300. Smart meter 340 may collect power usage and energy consumption information from sensors 320 and devices 330 and report the information to power company 350. Smart meter 340 may also receive information from power company 350 (e.g., the current unit cost for electricity, the current energy demand level in the neighborhood of environment 300, the current power consumption level, or the current level of power generated by power company 350) and supply that information to devices 330.

As an example, a device 330 in environment 300 may be an air condition system. The air condition system may be configured to adjust its operational behavior (e.g., whether to shut down or switch to an energy-saving model) based on the temperature of environment 300, the movements within environment 300, and the cost of electricity for environment 300. There may be a temperature sensor and a motion sensor in environment 300. From the temperature sensor, the air condition system may receive real-time temperature readings of environment 300, and from the motion sensor, the air condition system may receive real-time motion readings within environment 300. In addition, from smart meter 340, the air condition system may receive real time electricity pricing (e.g., the unit cost of electricity at a given time). The air condition system may be configured such that if there is no movement in environment 300 for a period of time (e.g., 10 minutes), then the air condition is shut down; or if the temperature reading in environment 300 is below a specific degree (e.g., 70 degrees Fahrenheit), then the air condition is shut down; or if the unit cost of electricity raises above a certain amount, then the air condition is shut down or switched to an energy-saving mode.

In addition, suppose environment 300 is relatively large and there are multiple air condition systems and multiple sensors deployed throughout environment 300. Each air condition system may receive real-time motion readings from a near-by motion sensor. If most of the activities are concentrated around one part of environment 300 as indicated by the motion sensors, the air condition system in that part of environment 300 may operate normally while the air condition systems in other parts of environment 300 may switch to the energy-saving mode.

As another example, a device 330 in environment 300 may be a television. The television may be configured to adjust its operational behavior (e.g., whether to dim the backlight) based on the movements near the television or the lighting level in environment 300. The television may subscribe to and receive real-time motion readings from a near-by motion sensor and real-time light readings from a light sensor. The television may be configured such that if there is no movement near by for a period of time or if the lighting level is above a certain level of brightness, then the television may dim its backlight or enter into an energy-saving mode.

Again, each specific device may be configured to receive specific types of external information from specific information providers and adjust its operational behavior based on the external information (e.g., according to a set of rules or settings).

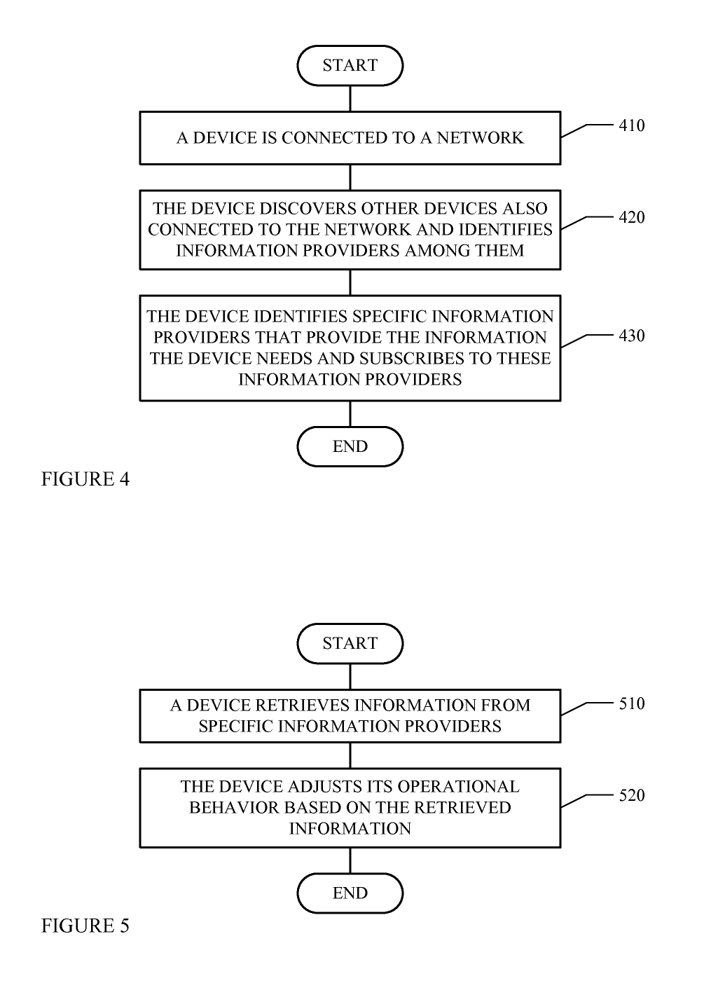

FIG. 4 illustrates an example method for an information consumer to subscribe to information from specific information providers. Suppose that the information consumer is an electronic device capable of connecting to a network. In particular embodiments, when the device is first connected to a network, as illustrated in STEP 410, the device may discover other information providers or information consumers already connected to the network, as illustrated in STEP 420. For example, the device may discover existing sensors, devices, or gateways already connected to the network as well as the types of information they provide. The device may determine which types of information it needs (e.g., according to the device's configuration), which specific information providers (e.g., sensors) supply these types of information, and the means to retrieve the needed information from these information providers (e.g., the API (application programming interface) used to retrieve the information), as illustrated in STEP 430. For example, if the device needs motion information, it should subscribe to a motion sensor. If the device needs temperature information, it should subscribe to a temperature sensor. The device may then subscribe to the information provided by these specific information providers.

The service discovery may be performed using various applicable network or communication protocols. For example, with UPnP, when a sensor is connected to a network, it broadcasts its unique identifier, sensor type, and interface so that other devices may query the current sensor reading from the sensor. When other devices (e.g., information consumers) receive the broadcast message, they become aware that the sensor is now available and the means to obtain sensor readings from that sensor.

In particular embodiments, a device (i.e., an information consumer) may execute a service discovery periodically or from time to time to retrieve a list of information providers currently connected to the network and the types of information they provide. The configuration of the network may change from time to time as new devices may be added to the network and existing devices may be removed from the network. The service discovery procedure enables a device to determine the information currently available over the network and its providers. When necessary, the device may adjust its information subscription according to the result of the service discovery. For example, if a new sensor is added to the network and the sensor provides a type of information that is useful to the device, the device may subscribe to receive information from the new sensor and retrieve sensor information from this sensor as needed.

In particular embodiments, a device (i.e., an information consumer) may have a list of information providers from which it receives and collects various types of information. The device may adjust its operational behavior based on the information received from these information providers. FIG. 5 illustrates an example method for an information consumer to adjust its operational behavior based on the external information received from information providers. In particular embodiments, a device may retrieve information from specific information providers from time to time, as illustrated in STEP 510, and adjust its operational behavior based on the retrieved information, as illustrated in STEP 520. Again, as described above, different devices or different types of devices may be configured to retrieve different types of information and adjust their operational behaviors based on the retrieved information according to different settings or rules.

Sometimes, a device may need a type of information that is not available over the network to which the device is connected. For example, if a device needs motion information but no motion sensor is connected to the network, then the device may not be able to obtain motion information from a suitable information provider. In this case, the device may not be able to adjust its operational behavior based on any motion information. The device may choose a default mode of operation and continue operating in the default mode until the motion information becomes available some time in the future.

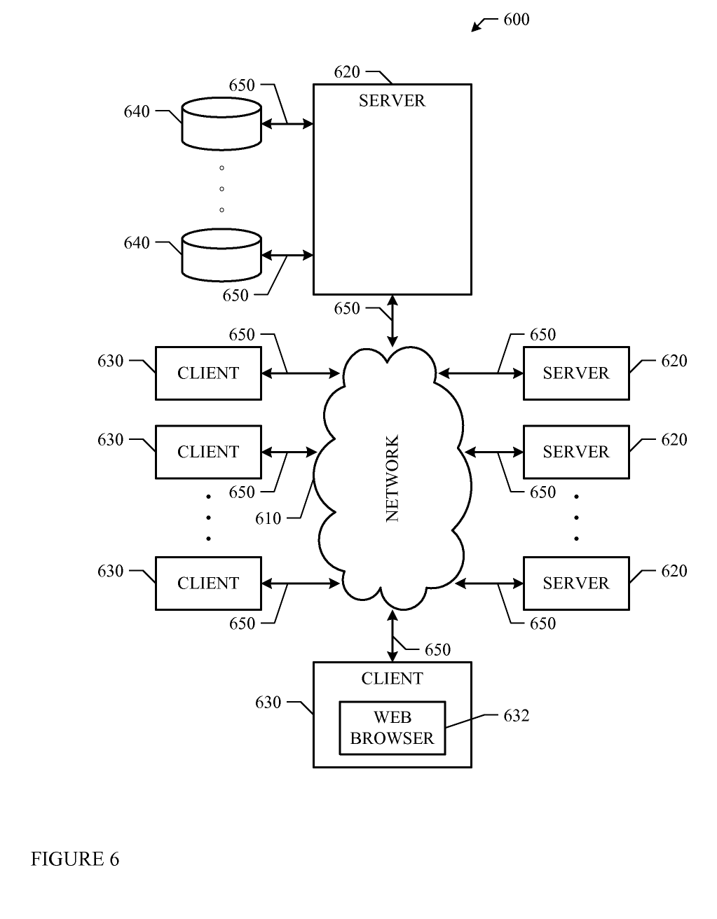

Particular embodiments may be implemented in a network environment. FIG. 6 illustrates an example network environment 600. Network environment 600 includes a network 610 coupling one or more servers 620 and one or more clients 630 to each other. In particular embodiments, network 610 is an intranet, an extranet, a virtual private network (VPN), a local area network (LAN), a wireless LAN (WLAN), a wide area network (WAN), a metropolitan area network (MAN), a portion of the Internet, or another network 610 or a combination of two or more such networks 610. This disclosure contemplates any suitable network 610.

One or more links 650 couple a server 620 or a client 630 to network 610. In particular embodiments, one or more links 650 each includes one or more wire line, wireless, or optical links 650. In particular embodiments, one or more links 650 each includes an intranet, an extranet, a VPN, a LAN, a WLAN, a WAN, a MAN, a portion of the Internet, or another link 650 or a combination of two or more such links 650. This disclosure contemplates any suitable links 650 coupling servers 620 and clients 630 to network 610.

In particular embodiments, each server 620 may be a unitary server or may be a distributed server spanning multiple computers or multiple datacenters. Servers 620 may be of various types, such as, for example and without limitation, web server, news server, mail server, message server, advertising server, file server, application server, exchange server, database server, or proxy server. In particular embodiments, each server 620 may include hardware, software, or embedded logic components or a combination of two or more such components for carrying out the appropriate functionalities implemented or supported by server 620. For example, a web server is generally capable of hosting websites containing web pages or particular elements of web pages. More specifically, a web server may host HTML files or other file types, or may dynamically create or constitute files upon a request, and communicate them to clients 630 in response to HTTP or other requests from clients 630. A mail server is generally capable of providing electronic mail services to various clients 630. A database server is generally capable of providing an interface for managing data stored in one or more data stores.

In particular embodiments, one or more data storages 640 may be communicatively linked to one or more severs 620 via one or more links 650. In particular embodiments, data storages 640 may be used to store various types of information. In particular embodiments, the information stored in data storages 640 may be organized according to specific data structures. In particular embodiments, each data storage 640 may be a relational database. Particular embodiments may provide interfaces that enable servers 620 or clients 630 to manage, e.g., retrieve, modify, add, or delete, the information stored in data storage 640.

In particular embodiments, each client 630 may be an electronic device including hardware, software, or embedded logic components or a combination of two or more such components and capable of carrying out the appropriate functionalities implemented or supported by client 630. For example and without limitation, a client 630 may be a desktop computer system, a notebook computer system, a netbook computer system, a handheld electronic device, or a mobile telephone. This disclosure contemplates any suitable clients 630. A client 630 may enable a network user at client 630 to access network 630. A client 630 may enable its user to communicate with other users at other clients 630.

A client 630 may have a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 630 may enter a Uniform Resource Locator (URL) or other address directing the web browser 632 to a server 620, and the web browser 632 may generate a Hyper Text Transfer Protocol (HTTP) request and communicate the HTTP request to server 620. Server 620 may accept the HTTP request and communicate to client 630 one or more Hyper Text Markup Language (HTML) files responsive to the HTTP request. Client 630 may render a web page based on the HTML files from server 620 for presentation to the user. This disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

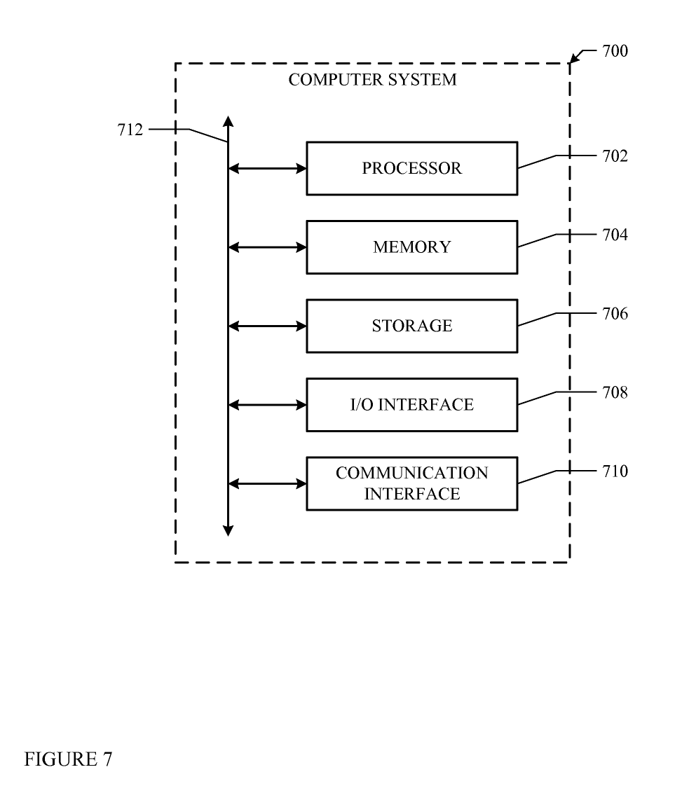

Particular embodiments may be implemented on one or more computer systems. FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 700 may include one or more computer systems 700; be unitary or distributed; span multiple locations; span multiple machines; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include an HDD, a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 702 (such as, for example, one or more internal registers or caches), one or more portions of memory 704, one or more portions of storage 706, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA, C, or C++. In particular embodiments, software is expressed in Hyper Text Markup Language (HTML), Extensible Markup Language (XML), or other suitable markup language.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A first electronic device comprising:
an information-filtering module configured to identify one or more second electronic devices that supply one or more types of information needed by the first electronic device;
an information-gathering module coupled to the information-filtering module configured to collect information from the second electronic devices; and
an operation module coupled to the information-gathering module configured to adjust operational behavior of the first electronic device based on the collected information.

2. The first electronic device of claim 1, wherein each second electronic device is configured to provide a description of the types of information it supplies.

3. The first electronic device of claim 2, wherein the information-gathering module is further configured to:
discover one or more electronic devices that supply information over a network; and
select from the electronic devices the second electronic devices that supply the types of information needed by the first electronic device.

4. The first electronic device of claim 3, wherein the information-filtering module is further configured to collect the information only from the second electronic devices that supply the types of information needed by the first electronic device.

5. The first electronic device of claim 1, wherein the second electronic devices comprises one or more sensors supplying one or more types of sensor information.

6. The first electronic device of claim 1, wherein the operational behavior of the first electronic device is adjusted based on the collected information according to one or more settings of the first electronic device.

7. The first electronic device of claim 1, wherein the operational behavior of the first electronic device is adjusted to save power consumption.

8. A method comprising: by a first electronic device,
identifying one or more second electronic devices that supply one or more types of information needed by the first electronic device;
collecting information from the second electronic devices; and
adjusting operational behavior of the first electronic device based on the collected information.

9. The method of claim 8, wherein each second electronic device is configured to provide a description of the types of information it supplies.

10. The method of claim 9, further comprising:
discovering one or more electronic devices that supply information over a network; and
selecting from the electronic device the second electronic devices that supply the types of information needed by the first electronic device.

11. The method of claim 10, further comprising collecting the information only from the second electronic devices that supply the types of information needed by the first electronic device.

12. The method of claim 8, wherein the second electronic devices comprises one or more sensors supplying one or more types of sensor information.

13. The method of claim 8, wherein the operational behavior of the first electronic device is adjusted based on the collected information according to one or more settings of the first electronic device.

14. The method of claim 8, wherein the operational behavior of the first electronic device is adjusted to save power consumption.

15. One or more computer-readable non-transitory storage media embodying software operable when executed by a first electronic device:
identify one or more second electronic devices that supply one or more types of information needed by the first electronic device;
collect information from the second electronic devices; and
adjust operational behavior of the first electronic device based on the collected information.

16. The media of claim 15, wherein each second electronic device is configured to provide a description of the types of information it supplies.

17. The media of claim 16, wherein the software is further operable when executed by the first electronic device to:
discover one or more electronic devices that supply information over a network; and
select from the electronic device the second electronic devices that supply the types of information needed by the first electronic device.

18. The media of claim 17, the software is further operable when executed by the first electronic device to collect the information only from the second electronic devices that supply the types of information needed by the first electronic device.

19. The media of claim 15, wherein the second electronic devices comprises one or more sensors supplying one or more types of sensor information.

20. The media of claim 15, wherein the operational behavior of the first electronic device is adjusted based on the collected information according to one or more settings of the first electronic device.

21. The media of claim 15, wherein the operational behavior of the first electronic device is adjusted to save power consumption.

22. A system comprising:
a memory comprising instructions executable by one or more processors; and
the one or more processors coupled to the memory and operable to execute the instructions, the one or more processors being operable when executing the instructions to:
identify one or more second electronic devices that supply one or more types of information needed by the first electronic device;
collect information from the second electronic devices; and
adjust operational behavior of the first electronic device based on the collected information.

23. A system comprising:
means for identifying one or more second electronic devices that supply one or more types of information needed by the first electronic device;
means for collecting information from the second electronic devices; and
means for adjusting operational behavior of the first electronic device based on the collected information.
